(19) United States
(12) Patent Application Publication
(10) Pub. No.: US 2024/0144061 A1
(43) Pub. Date: May 2, 2024

(54) PARTICLE PREDICTION FOR DYNAMIC OCCUPANCY GRID

(71) Applicant: QUALCOMM Incorporated, San Diego, CA (US)

(72) Inventors: Makesh Pravin JOHN WILSON, San Diego, CA (US); Radhika Dilip GOWAIKAR, San Diego, CA (US); Volodimir SLOBODYANYUK, San Diego, CA (US); Avdhut JOSHI, San Marcos, CA (US); James POPLAWSKI, Canton, MI (US)

(21) Appl. No.: 18/480,178

(22) Filed: Oct. 3, 2023

Related U.S. Application Data
(60) Provisional application No. 63/380,983, filed on Oct. 26, 2022.

(51) Int. Cl. G06N 7/01

(52) U.S. Cl. CPC G06N 7/01; B60W 60/00

(57) ABSTRACT

An occupancy grid probability prediction method includes: determining a dynamic particle probability based on a first probability that a dynamic particle will move from a donor cell of an occupancy grid to a recipient cell of the occupancy grid; and determining one or more predicted probabilities of at least one of the donor cell or the recipient cell based on the dynamic particle probability.

### CROSS-REFERENCE TO RELATED APPLICATIONS

This application claims the benefit of U.S. Provisional Application No. 63/380,983, filed Oct. 26, 2022, entitled “PARTICLE PREDICTION FOR DYNAMIC OCCUPANCY GRID,” which is assigned to the assignee hereof, and the entire contents of which are hereby incorporated herein by reference for all purposes.

### BACKGROUND

Vehicles are becoming more intelligent as the industry moves towards deploying increasingly sophisticated self-driving technologies that are capable of operating a vehicle with little or no human input, and thus being semi-autonomous or autonomous. Autonomous and semi-autonomous vehicles may be able to detect information about their location and surroundings (e.g., using ultrasound, radar, lidar, an SPS (Satellite Positioning System), and/or an odometer, and/or one or more sensors such as accelerometers, cameras, etc.). Autonomous and semi-autonomous vehicles typically include a control system to interpret information regarding an environment in which the vehicle is disposed to identify hazards and determine a navigation path to follow.

A driver assistance system may mitigate driving risk for a driver of an ego vehicle (i.e., a vehicle configured to perceive the environment of the vehicle) and/or for other road users. Driver assistance systems may include one or more active devices and/or one or more passive devices that can be used to determine the environment of the ego vehicle and, for semi-autonomous vehicles, possibly to notify a driver of a situation that the driver may be able to address. The driver assistance system may be configured to control various aspects of driving safety and/or driver monitoring. For example, a driver assistance system may control a speed of the ego vehicle to maintain at least a desired separation (in distance or time) between the ego vehicle and another vehicle (e.g., as part of an active cruise control system). The driver assistance system may monitor the surroundings of the ego vehicle, e.g., to maintain situational awareness for the ego vehicle. The situational awareness may be used to notify the driver of issues, e.g., another vehicle being in a blind spot of the driver, another vehicle being on a collision path with the ego vehicle, etc. The situational awareness may include information about the ego vehicle (e.g., speed, location, heading) and/or other vehicles or objects (e.g., location, speed, heading, size, object type, etc.).

A state of an ego vehicle may be used as an input to a number of driver assistance functionalities, such as an Advanced Driver assistance system (ADAS). Downstream driving aids such as an ADAS may be safety critical, and/or may give the driver of the vehicle information and/or control the vehicle in some way.

### SUMMARY

An example apparatus includes: a memory; and a processor communicatively coupled to the memory, and configured to: determine a dynamic particle probability based on a first probability that a dynamic particle will move from a donor cell of an occupancy grid to a recipient cell of the occupancy grid; and determine one or more predicted probabilities of at least one of the donor cell or the recipient cell based on the dynamic particle probability.

An example occupancy grid probability prediction method includes: determining a dynamic particle probability based on a first probability that a dynamic particle will move from a donor cell of an occupancy grid to a recipient cell of the occupancy grid; and determining one or more predicted probabilities of at least one of the donor cell or the recipient cell based on the dynamic particle probability.

Another example apparatus includes: means for determining a dynamic particle probability based on a first probability that a dynamic particle will move from a donor cell of an occupancy grid to a recipient cell of the occupancy grid; and means for determining one or more predicted probabilities of at least one of the donor cell or the recipient cell based on the dynamic particle probability.

An example non-transitory, processor-readable storage medium includes processor-readable instructions to cause a processor to: determine a dynamic particle probability based on a first probability that a dynamic particle will move from a donor cell of an occupancy grid to a recipient cell of the occupancy grid; and determine one or more predicted probabilities of at least one of the donor cell or the recipient cell based on the dynamic particle probability.

### BRIEF DESCRIPTION OF THE DRAWINGS

FIG. 1 is a top view of an example ego vehicle.

FIG. 2 is a block diagram of components of an example device, of which the ego vehicle shown in FIG. 1 may be an example.

FIG. 3 is a block diagram of components of an example transmission/reception point.

FIG. 4 is a block diagram of components of a server.

FIG. 5 is a block diagram of an example device.

FIG. 6 is a diagram of an example geographic environment.

FIG. 7 is a diagram of the geographic environment shown in FIG. 6 divided into a grid.

FIG. 8 is an example of an occupancy map corresponding to the grid shown in FIG. 7.

FIG. 9 is a block diagram of an example functional architecture for Bayesian filtering.

FIG. 10 is a block diagram of two-cell model for a dynamic particle.

FIG. 11 is a block diagram of a donor cell of an occupancy grid and recipient cells corresponding to the donor cell.

FIG. 12 is a block flow diagram of an occupancy grid probability prediction method.

### DETAILED DESCRIPTION

Techniques are discussed herein for predicting probabilities in dynamic occupancy grids. For example, a probability of a dynamic particle leaving a beginning cell of an occupancy grid and being received by an end cell is determined, e.g., using one or more known techniques, e.g., a Kalman Filter or general Bayesian filter, with a probability of a dynamic particle changing cells being a function of the velocity of the dynamic particle and size and layout of occupancy grid cells. A predicted probability of the beginning cell may be determined based on the probability of the dynamic particle leaving the beginning cell. For example, a dynamic probability portion of the predicted probability of the beginning cell may be reduced based on (e.g., by) the probability of the dynamic particle leaving the beginning cell and/or an empty probability portion of the predicted probability of the beginning cell may be increased based on (e.g., by) the probability of the dynamic particle leaving the beginning cell. Also or alternatively, a predicted probability of the end cell may be determined based on the probability of the dynamic particle entering the end cell. For example, based on the probability of the dynamic particle entering the end cell, a static probability portion of the predicted probability of the end cell may be reduced, a dynamic probability portion of the predicted probability of the end cell may be increased, an empty probability portion of the predicted probability of the end cell may be reduced, and/or an unknown probability portion of the predicted probability of the end cell may be reduced. Dynamic occupancy may be performed utilizing a two cell model (beginning cell and end cell) to indicate probability that particle moved from one cell to another cell. If a cell has an unknown probability, then an occupancy probability for that cell may be based on a dynamic particle probability, which will gradually decline. Other techniques, however, may be used.

Items and/or techniques described herein may provide one or more of the following capabilities, as well as other capabilities not mentioned. Occupancy grid accuracy and/or reliability may be improved. Probabilities, beliefs, and/or a plausibility of an occupancy grid for dynamic cells where one or more particles leave and/or enter a cell may be better predicted. Other capabilities may be provided and not every implementation according to the disclosure must provide any, let alone all, of the capabilities discussed.

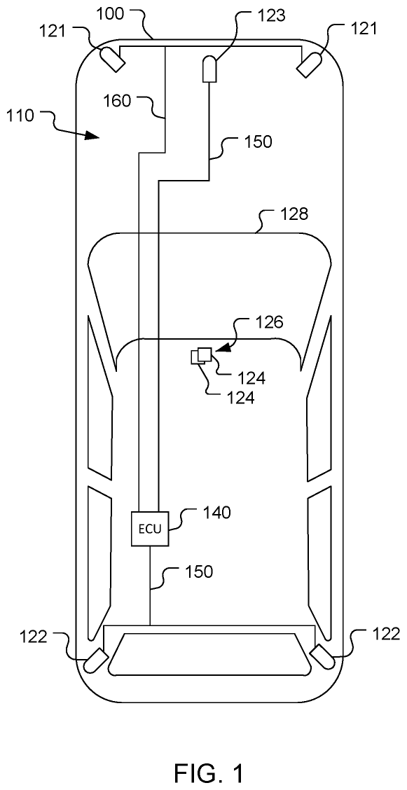

Referring to FIG. 1, an ego vehicle 100 includes an ego vehicle driver assistance system 110. The driver assistance system 110 may include a number of different types of sensors mounted at appropriate positions on the ego vehicle 100. For example, the system 110 may include: a pair of divergent and outwardly directed sensors 121 mounted at respective front corners of the vehicle 100, a similar pair of divergent and outwardly directed radar sensors 122 mounted at respective rear corners of the vehicle, a forwardly directed LRR sensor 123 (Long-Range Radar) mounted centrally at the front of the vehicle 100, and a pair of generally forwardly directed optical sensors 124 (cameras) forming part of an SVS 126 (Stereo Vision System) which may be mounted, for example, in the region of an upper edge of a windshield 128 of the vehicle 100. Each of the sensors 121 may include an LRR and/or an SRR (Short-Range Radar). The various sensors 121-124 may be operatively connected to a central electronic control system which is typically provided in the form of an ECU 140 (Electronic Control Unit) mounted at a convenient location within the vehicle 100. In the particular arrangement illustrated, the front and rear MRR sensors 121, 122 are connected to the ECU 140 via one or more conventional Controller Area Network (CAN) buses 150, and the LRR sensor 123 and the sensors of the SVS 126 are connected to the ECU 140 via a serial bus 160 (e.g., a faster FlexRay serial bus).

Collectively, and under the control of the ECU 140, the various sensors 121-124 may be used to provide a variety of different types of driver assistance functionalities. For example, the sensors 121-124 and the ECU 140 may provide blind spot monitoring, adaptive cruise control, collision prevention assistance, lane departure protection, and/or rear collision mitigation.

The CAN bus 150 may be treated by the ECU 140 as a sensor that provides ego vehicle parameters to the ECU 140. For example, a GPS module may also be connected to the ECU 140 as a sensor, providing geolocation parameters to the ECU 140.

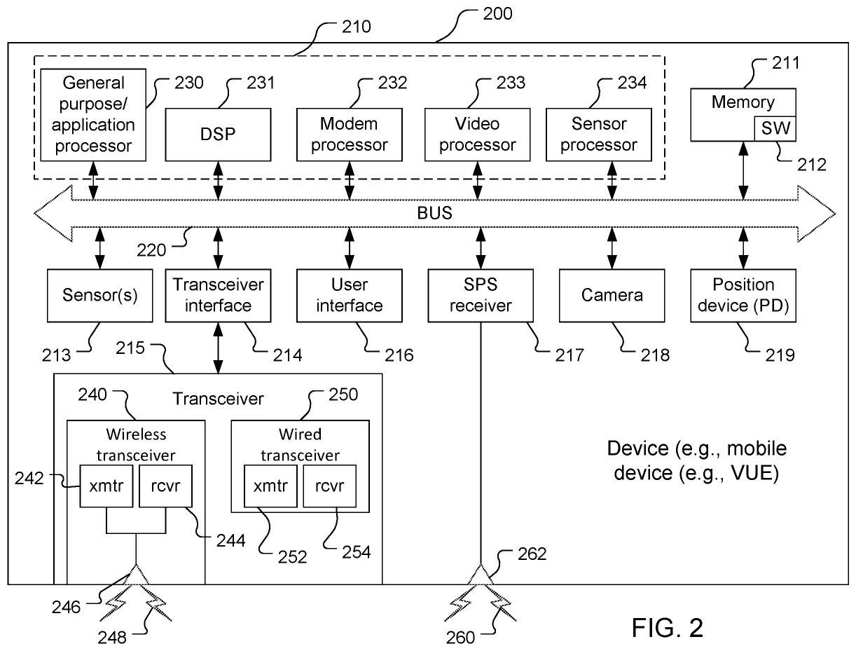

Referring also to FIG. 2, a device 200 (which may be a mobile device such as a user equipment (UE) such as a vehicle (VUE)) comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the device 200. The processor 210 may include one or more hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the device 200 for connectivity. The memory 211 is a non-transitory storage medium that may include random access memory (RAM), flash memory, disc memory, and/or read-only memory (ROM), etc. The memory 211 may store the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description herein may refer to the processor 210 performing a function, but this includes other implementations such as where the processor 210 executes software and/or firmware. The description herein may refer to the processor 210 performing a function as shorthand for one or more of the processors 230-234 performing the function. The description herein may refer to the device 200 performing a function as shorthand for one or more appropriate components of the device 200 performing the function. The processor 210 may include a memory with stored instructions in addition to and/or instead of the memory 211. Functionality of the processor 210 is discussed more fully below.

The configuration of the device 200 shown in FIG. 2 is an example and not limiting of the disclosure, including the claims, and other configurations may be used. For example, an example configuration of the UE may include one or more of the processors 230-234 of the processor 210, the memory 211, and the wireless transceiver 240. Other example configurations may include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The device 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The device 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the device 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the device 200 is fixed (stationary) or mobile and/or whether to report certain useful information, e.g., to an LMF (Location Management Function) regarding the mobility of the device 200. For example, based on the information obtained/measured by the sensor(s) 213, the device 200 may notify/report to the LMF that the device 200 has detected movements or that the device 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the device 200, etc.

The IMU may be configured to provide measurements about a direction of motion and/or a speed of motion of the device 200, which may be used in relative location determination. For example, one or more accelerometers and/or one or more gyroscopes of the IMU may detect, respectively, a linear acceleration and a speed of rotation of the device 200. The linear acceleration and speed of rotation measurements of the device 200 may be integrated over time to determine an instantaneous direction of motion as well as a displacement of the device 200. The instantaneous direction of motion and the displacement may be integrated to track a location of the device 200. For example, a reference location of the device 200 may be determined, e.g., using the SPS receiver 217 (and/or by some other means) for a moment in time and measurements from the accelerometer(s) and gyroscope(s) taken after this moment in time may be used in dead reckoning to determine present location of the device 200 based on movement (direction and distance) of the device 200 relative to the reference location.

The magnetometer(s) may determine magnetic field strengths in different directions which may be used to determine orientation of the device 200. For example, the orientation may be used to provide a digital compass for the device 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi-D), Bluetooth® short-range wireless communication technology, Zigbee® short-range wireless communication technology, etc. New Radio may use mm-wave frequencies and/or sub-6 GHz frequencies. The wired transceiver 250 may include a wired transmitter 252 and a wired receiver 254 configured for wired communication, e.g., a network interface that may be utilized to communicate with an NG-RAN (Next Generation-Radio Access Network) to send communications to, and receive communications from, the NG-RAN. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the device 200. For example, the user interface 216 may store indications of analog and/or digital signals in the memory 211 to be processed by DSP 231 and/or the general-purpose/application processor 230 in response to action from a user. Similarly, applications hosted on the device 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the device 200. For example, the SPS receiver 217 may be configured to determine location of the device 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the device 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the device 200.

The device 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the device 200, motion of the device 200, and/or relative position of the device 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the device 200 using terrestrial-based signals (e.g., at least some of the wireless signals 248) for trilateration, for assistance with obtaining and using the SPS signals 260, or both. The PD 219 may be configured to determine location of the device 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the device 200. The PD 219 may be configured to use one or more other techniques (e.g., relying on the UE's self-reported location (e.g., part of the UE's position beacon)) for determining the location of the device 200, and may use a combination of techniques (e.g., SPS and terrestrial positioning signals) to determine the location of the device 200. The PD 219 may include one or more of the sensors 213 (e.g., gyroscope(s), accelerometer(s), magnetometer(s), etc.) that may sense orientation and/or motion of the device 200 and provide indications thereof that the processor 210 (e.g., the general-purpose/application processor 230 and/or the DSP 231) may be configured to use to determine motion (e.g., a velocity vector and/or an acceleration vector) of the device 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the device 200, and may be provided by hardware, software, firmware, or various combinations thereof.

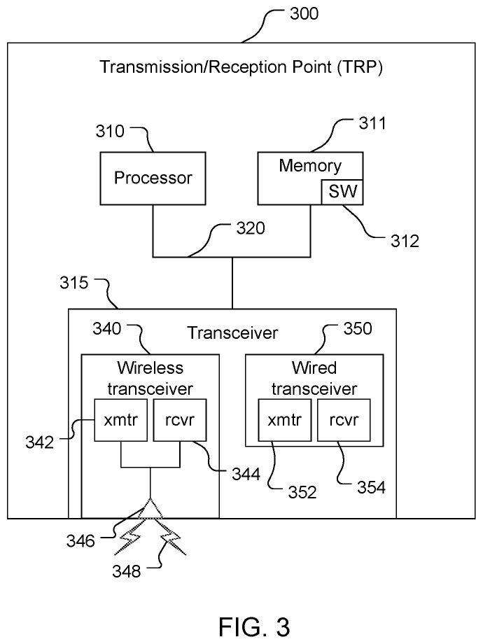

Referring also to FIG. 3, an example of a TRP 300 (e.g., of a base station such as a gNB (general NodeB) and/or an ng-eNB (next generation evolved NodeB) may comprise a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 may be a non-transitory storage medium that may include random access memory (RAM)), flash memory, disc memory, and/or read-only memory (ROM), etc. The memory 311 may store the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description herein may refer to the processor 310 performing a function, but this includes other implementations such as where the processor 310 executes software and/or firmware. The description herein may refer to the processor 310 performing a function as shorthand for one or more of the processors contained in the processor 310 performing the function. The description herein may refer to the TRP 300 performing a function as shorthand for one or more appropriate components (e.g., the processor 310 and the memory 311) of the TRP 300 performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 350 may include a wired transmitter 352 and a wired receiver 354 configured for wired communication, e.g., a network interface that may be utilized to communicate with an NG-RAN to send communications to, and receive communications from, an LMF, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 may be configured to perform or performs several functions, but one or more of these functions may be performed by an LMF and/or the device 200 (i.e., an LMF and/or the device 200 may be configured to perform one or more of these functions).

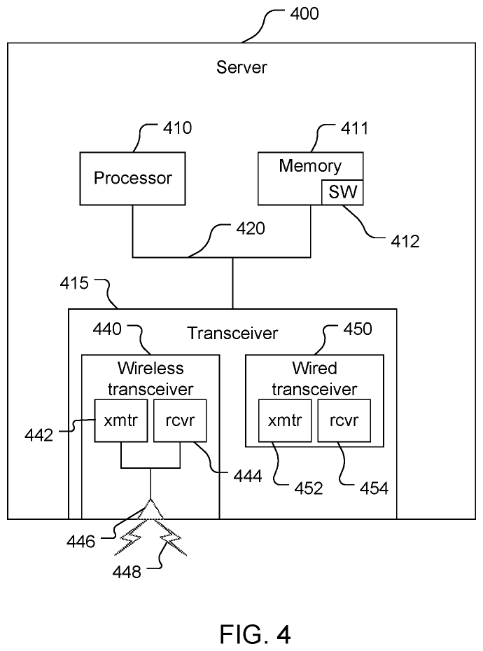

Referring also to FIG. 4, a server 400, of which an LMF is an example, may comprise a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 may be a non-transitory storage medium that may include random access memory (RAM)), flash memory, disc memory, and/or read-only memory (ROM), etc. The memory 411 may store the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description herein may refer to the processor 410 performing a function, but this includes other implementations such as where the processor 410 executes software and/or firmware. The description herein may refer to the processor 410 performing a function as shorthand for one or more of the processors contained in the processor 410 performing the function. The description herein may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the device 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi® short-range wireless communication technology, WiFi® Direct (WiFi®-D), Bluetooth® short-range wireless communication technology, Zigbee® short-range wireless communication technology, etc. The wired transceiver 450 may include a wired transmitter 452 and a wired receiver 454 configured for wired communication, e.g., a network interface that may be utilized to communicate with an NG-RAN to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the device 200 (i.e., the TRP 300 and/or the device 200 may be configured to perform one or more of these functions).

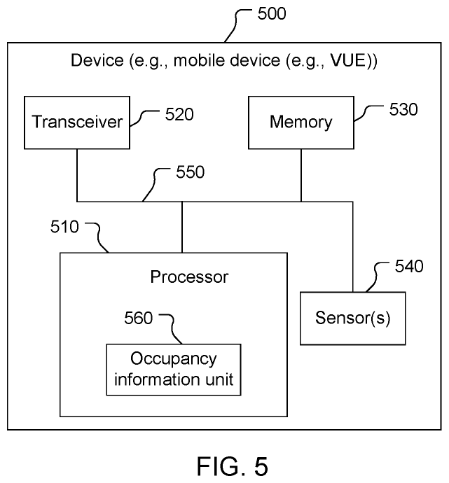

Referring to FIG. 5, a device 500 includes a processor 510, a transceiver 520, a memory 530, and sensors 540, communicatively coupled to each other by a bus 550. Even if referred to in the singular, the processor 510 may include one or more processors, the transceiver 520 may include one or more transceivers (e.g., one or more transmitters and/or one or more receivers), and the memory 530 may include one or more memories. The device 500 may take any of a variety of forms such as a mobile device such as a vehicle UE (VUE). The device 500 may include the components shown in FIG. 5, and may include one or more other components such as any of those shown in FIG. 2 such that the device 200 may be an example of the device 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the device 500 performing a function as shorthand for one or more appropriate components (e.g., the processor 510 and the memory 530) of the device 500 performing the function. The processor 510 (possibly in conjunction with the memory 530 and, as appropriate, the transceiver 520) may include an occupancy information unit 560 (which may include an ADAS (Advanced Driver Assistance System) for a VUE). The occupancy information unit 560 is discussed further herein, and the description herein may refer to the occupancy information unit 560 performing one or more functions, and/or may refer to the processor 510 generally, or the device 500 generally, as performing any of the functions of the occupancy information unit 560, with the device 500 being configured to perform the functions.

One or more functions performed by the device 500 (e.g., the occupancy information unit 560) may be performed by another entity. For example, sensor measurements (e.g., radar measurements, camera measurements (e.g., pixels, images)) and/or processed sensor measurements (e.g., a camera image converted to a bird's-eye-view image) may be provided to another entity, e.g., the server 400, and the other entity may perform one or more functions discussed herein with respect to the occupancy information unit 560 (e.g., using machine learning to determine and/or apply an observation model, analyzing measurements from different sensors to determine a present occupancy grid, etc.).

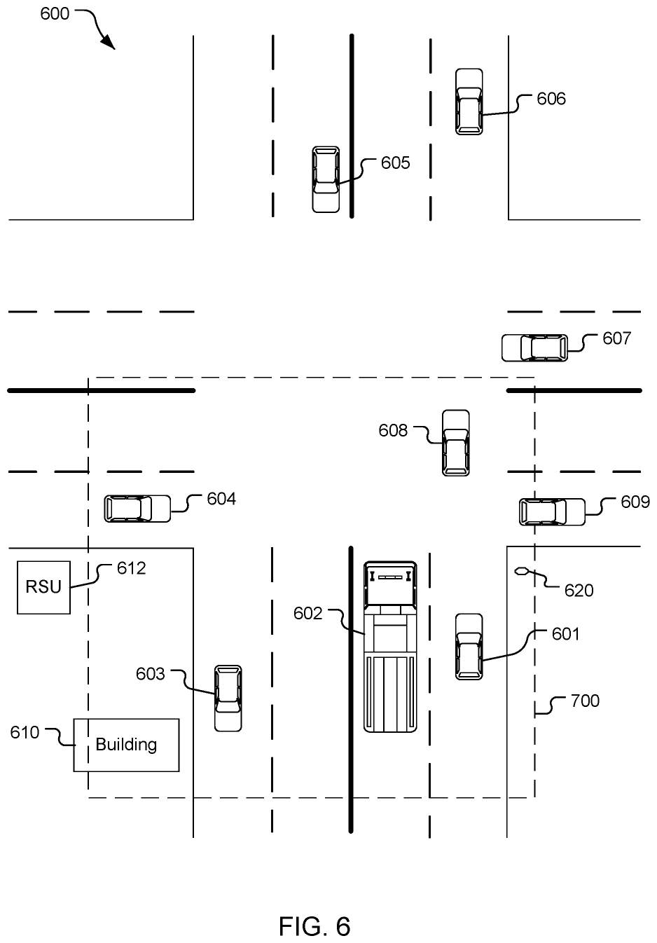

Referring also to FIG. 6, a geographic environment 600, in this example a driving environment, includes multiple mobile wireless communication devices, here vehicles 601, 602, 603, 604, 605, 606, 607, 608, 609, a building 610, an RSU 612 (Roadside Unit), and a street sign 620 (e.g., a stop sign). The RSU 612 may be configured similarly to the TRP 300, although perhaps having less functionality and/or shorter range than the TRP 300, e.g., a base-station-based TRP. One or more of the vehicles 601-609 may be configured to perform autonomous driving. A vehicle whose perspective is under consideration (e.g., for environment evaluation, autonomous driving, etc.) may be referred to as an observer vehicle or an ego vehicle. An ego vehicle, such as the vehicle 601 may evaluate a region around the ego vehicle for one or more desired purposes, e.g., to facilitate autonomous driving. The vehicle 601 may be an example of the device 500. The vehicle 601 may divide the region around the ego vehicle into multiple sub-regions and evaluate whether an object occupies each sub-region and if so, may determine one or more characteristics of the object (e.g., size, shape (e.g., dimensions (possibly including height)), velocity (speed and direction), object type (bicycle, car, truck, etc.), etc.).

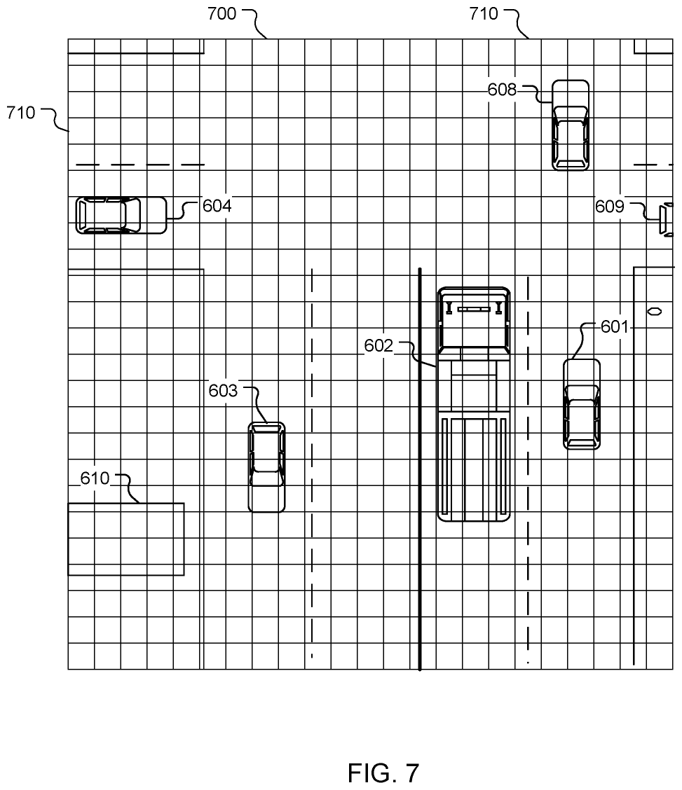

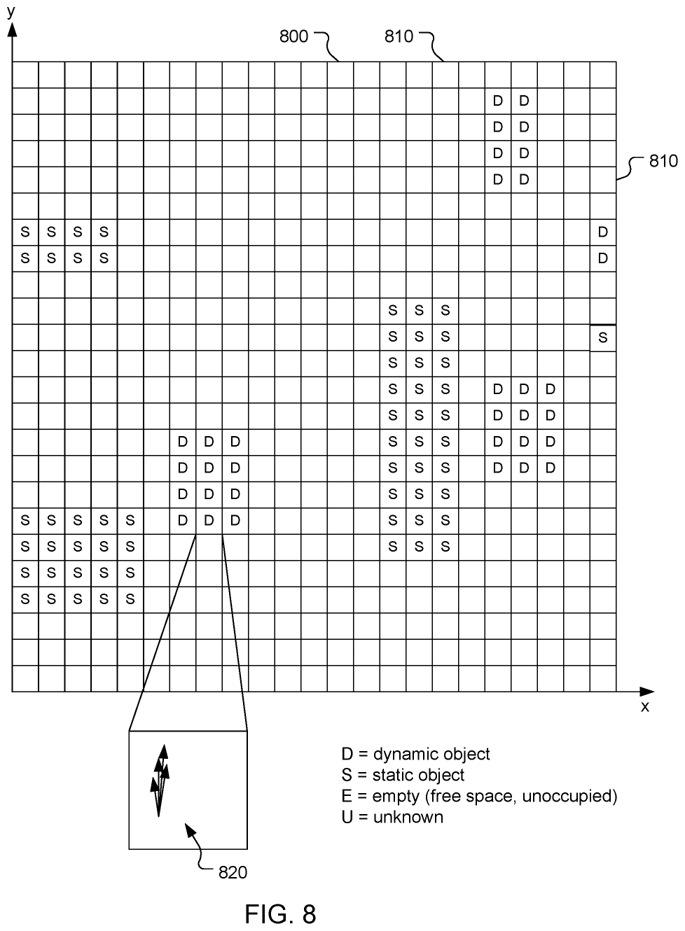

Referring also to FIGS. 7 and 8, a region 700, which in this example spans a portion of the environment 600, may be evaluated to determine an occupancy grid 800 (also called an occupancy map) that indicates an occupier type for each of multiple sub-regions of the region 700. For example, the region 700 may be divided into a grid, which may be called an occupancy grid, with sub-regions 710 that may be of similar (e.g., identical) size and shape, or may have two or more sizes and/or shapes (e.g., with sub-regions being smaller near an ego vehicle, e.g., the vehicle 601, and larger further away from the ego vehicle, and/or with sub-regions having different shape(s) near an ego vehicle than sub-region shape(s) further away from the ego vehicle). The region 700 and the grid 800 may be regularly-shaped (e.g., a rectangle, a triangle, a hexagon, an octagon, etc.) and/or may be divided into identically-shaped, regularly-shaped sub- regions for convenience sake, e.g., to simplify calculations, but other shapes of regions/grids (e.g., an irregular shape) and/or sub-regions (e.g., irregular shapes, multiple different regular shapes, or a combination of one or more irregular shapes and one or more regular shapes) may be used. For example, the sub-regions 710 may have rectangular (e.g., square) shapes. The region 700 may be of any of a variety of sizes and have any of a variety of granularities of sub-regions. For example, the region 700 may be a rectangle (e.g., a square) of about 100 m per side. As another example, while the region 700 is shown with the sub-regions 710 being squares of about 1 m per side, other sizes of sub-regions, including much smaller sub-regions, may be used. For example, square sub-regions of about 25 cm per side may be used. In this example, the region 700 is divided into M rows (here, 24 rows parallel to an x-axis indicated in FIG. 8) of N columns each (here, 23 columns parallel to a y-axis as indicated in FIG. 8).

Each of the sub-regions 710 may correspond to a respective cell 810 of the occupancy map and information may be obtained regarding what, if anything, occupies each of the sub-regions 710 in order to populate cells 810 of the occupancy map 800 with an occupancy indication indicative of a type of occupier of the sub-region corresponding to the cell. The information as to what, if anything, occupies each of the sub-regions 710 may be obtained from one or more of a variety of sources. For example, occupancy information may be obtained from one or more sensor measurements from one or more of the sensors 540 of the device 500. As another example, occupancy information may be obtained by one or more other devices and communicated to the device 500. For example, one or more of the vehicles 602-609 may communicate, e.g., via C-V2X communications, occupancy information to the vehicle 601. As another example, the RSU 612 may gather occupancy information (e.g., from one or more sensors of the RSU 612 and/or from communication with one or more of the vehicles 602-609 and/or one or more other devices) and communicate the gathered information to the vehicle 601, e.g., directly and/or through one or more network entities, e.g., TRPs.

As shown in FIG. 8, each of the cells 810 may include occupancy information indicating a type of occupier of the sub-region 710 corresponding to the cell 810. As examples, the occupancy information may indicate that the corresponding sub-region 710 is occupied by a static object (S), or may indicate that the corresponding sub-region 710 is occupied by a dynamic object (D) that is or may be mobile, or may indicate that the corresponding sub-region 710 is occupied by free space and is thus empty (E) or unoccupied, or may indicate that the occupancy of the corresponding sub-region is unknown (U), e.g., if there is no information as to a possible occupier of the corresponding sub-region 710. Each of the cells 810 may include respective probabilities of the cell 810 being static, dynamic, empty, or unknown, with a sum of the probabilities being 1. In the example shown in FIG. 8, empty cells are not labeled in the occupancy grid 800 for sake of simplicity of the figure and readability of the occupancy grid 800.

Building a dynamic occupancy grid (an occupancy grid with a dynamic occupier type) may be helpful, or even essential, for understanding an environment (e.g., the environment 600) of an apparatus to facilitate or even enable further processing. For example, a dynamic occupancy grid may be helpful for predicting occupancy, for motion planning, etc. A dynamic occupancy grid may, at any one time, comprise one or more cells of static occupier type and/or one or more cells of dynamic occupier type. A dynamic object may be represented as a collection of velocity vectors. For example, an occupancy grid cell may have some or all of the occupancy probability be dynamic, and within the dynamic occupancy probability, there may be multiple (e.g., four) velocity vectors 820 each with a corresponding probability that together sum to the dynamic occupancy probability for that cell 810. A dynamic occupancy grid may be obtained, e.g., by the occupancy information unit 560, by processing information from multiple sensors, e.g., of the sensors 540, such as from a radar system, a camera, etc.

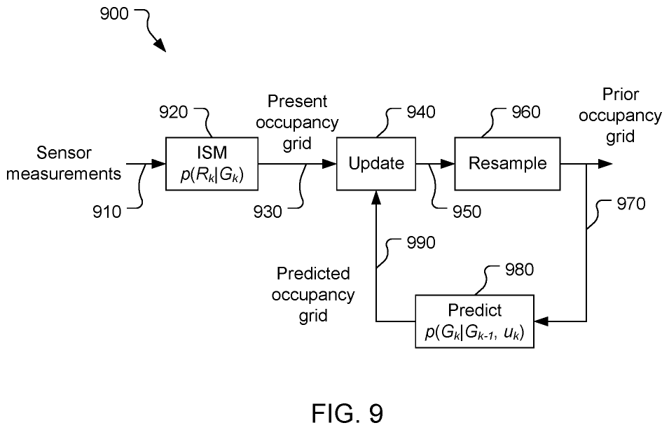

Referring also to FIG. 9, the occupancy information unit 560 may be configured to implement a Bayes Filter approach to predict occupancy grids and update occupancy grids based on an observation model. A functional architecture 900 illustrates Bayesian filtering. Sensor measurements 910 (e.g., radar measurements) may be used by an observation model function 920 (also called an ISM (Interpretive Structural Model) function) that uses a conditional probability of radar measurements and an occupancy grid to determine a present occupancy grid 930 (also called an observation occupancy grid). The occupancy information unit 560 may use the present occupancy grid 930 and a predicted occupancy grid 990 to perform an update function 940 of the predicted occupancy grid 990 to produce an updated occupancy grid 950 on which the occupancy information unit 560 may perform a resample function 960 to produce what then becomes a prior occupancy grid 970 that may be provided to any appropriate user of the updated occupancy grid (e.g., an autonomous driving application, a motion planner, etc.) and used for prediction of the next occupancy grid. The occupancy information unit 560 may use the prior occupancy grid 970 in a prediction function 980 to determine the predicted occupancy grid 990. The occupancy information unit 560 may perform the prediction function 980 according to

[symbol]

(Gₖ)=∫p(Gₖ|G₋₁, uₖ)bel(Gₖ₋₁)dGₖ₋₁ (1)

where Gₖ is an N×N occupancy grid at time k (i.e., the present occupancy grid 930), and is a dynamic occupancy grid (a DOGMa (Dynamic Occupancy Grid Map)), and may be implemented as a particle filter, Gₖ₋₁ is an occupancy grid at time k−1 (i.e., the prior occupancy grid 970), uₖ is action data, dGₖ is a differential element, bel(Gₖ₋₁) is the update for the prior occupancy grid, and p indicates probability. The occupancy information unit 560 may perform the update function 940 for the predicted occupancy grid 990 according to

bel(Gₖ)=ηp(Rₖ|Gₖ) [symbol] (Gₖ) (2)

where p(Rₖ|Gₖ) is the observation model for sensor measurements at time k (in this example, radar measurements Rₖ at time k), and η is a normalizing constant.

With a dynamic occupancy grid, as opposed to a static occupancy grid, the state (i.e., the collection of occupier type probabilities) of any given cell may depend on the states of neighboring cells. State prediction for static cells (e.g., empty, static object) may be straightforward, and the probability of the same state in the next frame (sampling in time) is very high. In the dynamic case, the state of a grid cell is dependent upon the state of that cell and also the states of other cells (e.g., neighbor cells that are adjacent to the cell in question as well as cells further away from each of which a dynamic object in the other cell at the prior frame may depart the other cell and arrive in the cell in question by the present frame). State prediction may thus be multi-dimensional, which may be very complex. Further, multiple sub-probabilities being available for each dynamic cell probability (e.g., for each of multiple velocity vectors, each of which is a particle) will add to the complexity. Further adding to the complexity, if probabilities are not constrained by reality, then a total probability for a cell may be higher than 1. Low-complexity rules may be applied, however, to manage the complexity of state prediction for dynamic occupancy grids.

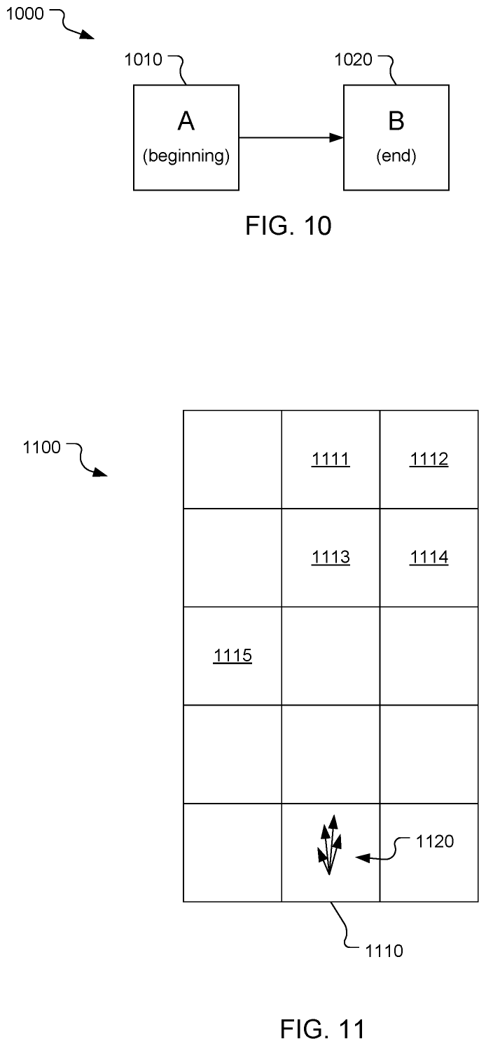

Referring to FIG. 10, a two-cell model 1000 may be used to develop low-complexity rules for determining occupancy grid state. The two-cell model 1000 includes a beginning cell 1010 (which may be called a donor cell) and an end cell 1020 (which may be called a recipient cell) in an occupancy grid. A dynamic particle is expected to move from the beginning cell 1010 to the end cell 1020 between consecutive frames of the occupancy grid, hence the dynamic particle being donated by the donor cell to the recipient cell. A state probability for the beginning cell 1010 may comprise a static probability, a dynamic probability, an empty probability, and an unknown probability as follows

p_{A}=[p_{A,S}, p_{A,D}, p_{A,E}, p_{A,U}] (3)

The state of a cell may be assumed to be the portion of the state with the highest probability, and the probability of that portion may be made to be 1 and the other probabilities made to be 0. The state of a cell before prediction may be any of static (S), dynamic (D), empty (E), or unknown (U) and the state after prediction may also be any of static, dynamic, empty, or unknown. Thus, for each of 16 possible combinations of states of the cells 1010, 1020 before prediction (SS, SD, SE, SU, DS, . . . , UE, UU), there are 16 possible combinations of states of the cells after prediction (SS, SD, SE, SU, DS, . . . , UE, UU). This is much lower complexity than if the states of each of the cells 1010, 1020 included all four possible states with respective probabilities, especially if the dynamic state includes multiple sub-states (e.g., multiple velocity vectors).

Predictions may be made of state probabilities based on the expected move of the dynamic particle from the beginning cell 1010 to the end cell 1020. The state probabilities of the cells 1010, 1020 before prediction may be represented as p_{A}^{k-1}, p_{B}^{k-1}, and the state probabilities of the cells 1010, 1020 after prediction may be represented as p_{A}^{k-1}, p_{B}^{k-1}. As an example, the predicted probabilities of the cells 1010, 1020 in view of a particular particle moving from the beginning cell 1010 to the end cell 1020 may be given by

p_{A}^{k}=[p_{A,S}^{k-1}, p_{A,D}^{k-1}−δ, p_{A,E}^{k-1}+δ, p_{A,U}^{k-1}] (4)

p_{B}^{k}=[p_{B,S}^{k-1}−δp_{B,S}^{k-1}, p_{B,D}^{k-1}+δp_{B,E}^{k-1}, p_{B,E}^{k-1}−δp_{B,E}^{k-1}, p_{B,U}^{k-1}+δp_{B,S}^{k-1}] (5)

where k is the present time step, δ is a dynamic particle probability which is the probability that a particular dynamic particle will move from the beginning cell 1010 to the end cell 1020, p_{A,S}^{k-1} is the probability of the static sub-state of the cell 1010 before prediction, p_{A,D}^{k-1} is the probability of the dynamic sub-state of the cell 1010 before prediction, p_{A,E}^{k-1} is the probability of the empty sub-state of the cell 1010 before prediction, p_{A,U}^{k-1} is the probability of the unknown sub-state of the cell 1010 before prediction, p_{B,S}^{k-1} is the probability of the static sub-state of the end cell 1020 before prediction, p_{B,D}^{k-1} is the probability of the dynamic sub-state of the end cell 1020 before prediction, p_{B,E}^{k-1} is the probability of the empty sub-state of the end cell 1020 before prediction, p_{B,U}^{k-1} is the probability of the unknown sub-state of the end cell 1020 before prediction. Equations (4) and (5) provide heuristic updates to the cells 1010, 1020. As indicated in Equation (4) a cell, here the cell 1010, that loses one or more dynamic particles with a corresponding probability δ has the lost probability subtracted from the dynamic sub-state probability (indicated by p_{A,D}^{k-1}−δ) accounted for by an increase in the empty sub-state probability (indicated by p_{A,D}^{k-1}+δ). Further, as indicated in Equation (5), a cell, here the cell 1020, that gains one or more dynamic particles has the dynamic sub-state probability increased by a product of the probability of a dynamic particle entering the cell and the probability of the empty sub-state (indicated by p_{B,D}^{k-1}+δp_{B,E}^{k-1}), has the empty sub-state probability reduced by the same amount (indicated by p_{B,E}^{k-1}−δp_{B,E}^{k-1}) but to no lower than 0, and has the probability of the static sub-state reduced by a product of the probability of a dynamic particle entering the cell and the probability of the static sub-state (indicated by p_{B,S}^{k-1}−δp_{B,S}^{k-1}) and the probability of the unknown sub-state increased by the same amount (indicated by p_{B,S}^{k-1}+δp_{B,S}^{k-1}).

The two-cell model 1000 may be extended to multiple cells to determine a predicted occupancy grid. For example, the occupancy information unit 560 may be configured to perform the predictions of Equations (4) and (5) for each dynamic cell, e.g., each cell with a non-zero dynamic particle probability and each cell that may receive a dynamic particle (e.g., based on grid cell size, time between frames, and dynamic particle velocity(ies)). For example, referring also to FIG. 11, a dynamic occupancy grid portion 1100 includes a cell 1110 with four velocity vectors 1120. The velocity vectors 1120 each have a corresponding probability and indicate that a respective dynamic particle will depart from the cell 1110 and enter, at least partially, one or more of cells 1111, 1112, 1113, 1114, 1115, respectively. A single particle may leave from the cell 1110 (a donor cell) and be received by each of multiple recipient cells (due to direction of movement, object size, occupancy grid resolution, etc.). Consequently, Equation (4) may be applied to the cell 1110 and Equation (5) may be applied to the cells 1111-1115 with respective probabilities of the dynamic particle leaving the cell 1110 and being received by a respective one of the cells 1111-1115.

Probabilities of multiple dynamic particles may be summed to determine a composite dynamic particle probability. Multiple dynamic particle probabilities corresponding to multiple respective dynamic particles, expected to leave the beginning cell 1110 for each of one or more recipient cells, may be summed to determine a composite dynamic particle probability for a beginning cell as follows

δ_{cb}=Σᵢ₌₁ⁿδ_{b,i} (6)

where δ_{cb} is the composite dynamic particle probability for the beginning cell (i.e., the dynamic particles leaving the beginning cell 1110), and δ_{b,i} is the dynamic particle probability of the i^{th} dynamic particle expected to leave the beginning cell 1110. That is, the composite dynamic particle probability for determining the predicted probability sub-states of the beginning cell 1110, in the case of multiple dynamic particles leaving the beginning cell 1110, is the sum of respective probabilities of each of the dynamic particles expected to leave the beginning cell 1110. The predicted probability of the beginning cell 1110 may be expressed as

p_{A}^{k}=[p_{A,S}^{k-1}, p_{A,D}^{k-1}−δ_{cb}, p_{A,E}^{k-1}+δ_{cb}, p_{A,U}^{k-1}] (7)

The value of δ_{cb} may represent the percentage of particles leaving a cell, e.g., in a particle filter representation. For example, if a grid cell has 50 particles representing a probability of 0.5, and after prediction 10 of 50 particles moved out of the cell, then δ_{cb} may be 20% of 0.5, i.e., 0.1. Multiple dynamic particle probabilities corresponding to multiple respective dynamic particles, expected to enter a single recipient cell, may be summed to form a composite dynamic particle probability for the recipient cell before being multiplied by the present static and empty sub-state probabilities. That is, the composite dynamic particle probability for determining the predicted probability sub-states of a recipient cell, in the case of multiple dynamic particles expected to enter the recipient cell, is the sum of respective probabilities that each of the dynamic particles will move from outside the recipient cell (from one or more donor cells) to inside the recipient cell. Thus, the composite dynamic particle probability for a recipient cell and the predicted probability of the recipient cell may be expressed as

δ_{cr}=Σⱼ₌₁ⁿδ_{r,j} (8)

p_{B}^{k}=[p_{B,S}^{k-1}−δp_{B,S}^{k-1}, p_{B,D}^{k-1}+δ_{cr}p_{B,E}^{k-1}, p_{B,E}^{k-1}−δ_{cr}p_{B,E}^{k-1}, p_{B,U}^{k-1}+δp_{cr}p_{B,S}^{k-1}] (9)

where δ_{cr} is the composite dynamic particle probability for the beginning cell (i.e., the particles received by the recipient cell from one or more beginning cells), and δ_{r,j} is the dynamic particle probability of the j^{th} dynamic particle expected to enter the recipient cell.

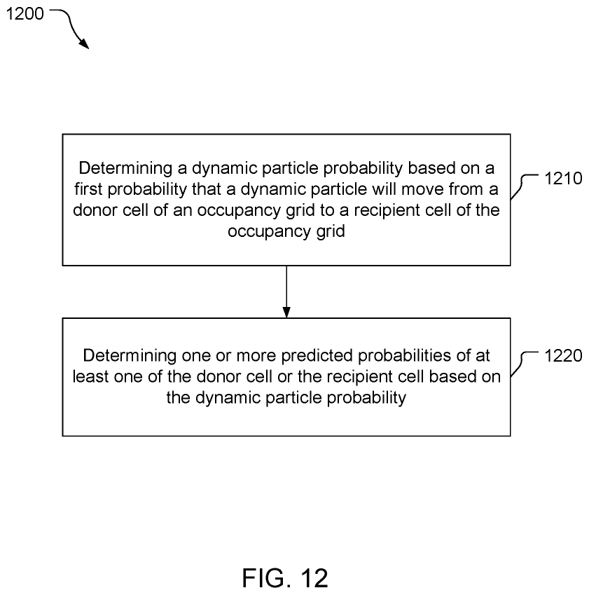

Referring to FIG. 12, with further reference to FIGS. 1-12, an occupancy grid probability prediction method 1200 includes the stages shown. The method 1200 is, however, an example and not limiting. The method 1200 may be altered, e.g., by having one or more stages added, removed, rearranged, combined, performed concurrently, and/or having one or more stages each split into multiple stages.

At stage 1210, the method 1200 includes determining a dynamic particle probability based on a first probability that a dynamic particle will move from a donor cell of an occupancy grid to a recipient cell of the occupancy grid. For example, the occupancy information unit 560 (or another entity, e.g., the server 400) may determine the dynamic particle probability δ or the composite dynamic particle probability δ_{cb} for a beginning (donor) cell or the composite dynamic particle probability δ_{cr} for a recipient cell. The occupancy information unit 560 (or other entity) may determine the dynamic particle probability by receiving and reading a message containing the dynamic particle probability. The processor 510, possibly in combination with the memory 530, possibly in combination with the wireless receiver 244 and the antenna 246 or the wired receiver 254, or the processor 410, possibly in combination with the memory 411, possibly in combination with the wireless receiver 444 and the antenna 446 or the wired receiver 454, may comprise means for determining the dynamic particle probability.

At stage 1220, the method 1200 includes determining one or more predicted probabilities of at least one of the donor cell or the recipient cell based on the dynamic particle probability. For example, the occupancy information unit 560 or other entity may determine a predicted probability of the beginning cell 1110 and/or a recipient cell (e.g., one of the end cells 1111-1115), e.g., based on Equation (4), or Equation (5), or Equations (6) and (7), or Equations (8) and (9), or one or more respective portions, or based on other relationships (e.g., by reducing the dynamic particle probability, e.g., by half or another amount). The processor 510, possibly in combination with the memory 530, or the processor 410 possibly in combination with the memory 411, may comprise means for determining one or more predicted probabilities.

Implementations of the method 1200 may include one or more of the following features. In an example implementation, determining the one or more predicted probabilities comprises: determining a predicted dynamic probability of the donor cell by reducing a present dynamic probability of the donor cell based on the dynamic particle probability; or determining a predicted empty probability of the donor cell by increasing a present empty probability of the donor cell based on the dynamic particle probability; or a combination thereof. For example, the occupancy information unit 560 or other entity may determine the predicted probability of the beginning cell 1110, e.g., based on the predicted dynamic sub-state probability determination in Equation (4) and/or based on the predicted empty sub-state probability determination in Equation (4). Sub-state probability determinations other than those shown in Equation (4) may be used, e.g., using one or more of the sub-state probability determinations shown in Equation (4) but with the dynamic particle probability reduced. The processor 510, possibly in combination with the memory 530, or the processor 410 possibly in combination with the memory 411, may comprise means for determining the predicted dynamic probability of the donor cell and/or means for determining the predicted empty probability of the donor cell. In a further example implementation, the dynamic particle probability is a composite dynamic particle probability, the dynamic particle is a first dynamic particle, the recipient cell is a first recipient cell, and wherein determining the one or more predicted probabilities comprises: determining a second probability that a second dynamic particle will move from the donor cell to a second recipient cell of the occupancy grid; and determining the composite dynamic particle probability by adding the first probability and the second probability. For example, the occupancy information unit 560 or other entity may determine the composite dynamic particle probability according to Equation (6) and determine the predicted probability of the beginning cell 1110, e.g., based on the predicted dynamic sub-state probability determination in Equation (7) and/or based on the predicted empty sub-state probability determination in Equation (7). The processor 510, possibly in combination with the memory 530, or the processor 410 possibly in combination with the memory 411, may comprise means for determining the second probability and means for determining the composite dynamic particle probability.

Also or alternatively, implementations of the method 1200 may include one or more of the following features. In an example implementation, determining the one or more predicted probabilities comprises: determining a predicted dynamic probability of the donor cell by subtracting the dynamic particle probability from a present dynamic probability of the donor cell; or determining a predicted empty probability of the donor cell by adding the dynamic particle probability to a present empty probability of the donor cell; or a combination thereof. For example, the occupancy information unit 560 or other entity may determine the predicted probability of the beginning cell 1110, e.g., based on the predicted dynamic sub-state probability determination in Equation (4) and/or based on the predicted empty sub-state probability determination in Equation (4). The processor 510, possibly in combination with the memory 530, or the processor 410 possibly in combination with the memory 411, may comprise means for determining the predicted dynamic probability of the donor cell and/or means for determining the predicted empty probability of the donor cell.

Also or alternatively, implementations of the method 1200 may include one or more of the following features. In an example implementation, determining the one or more predicted probabilities comprises: (1) determining a predicted static probability of the recipient cell by reducing a present static probability of the recipient cell based on the dynamic particle probability; or (2) determining a predicted dynamic probability of the recipient cell by increasing a present dynamic probability of the recipient cell based on the dynamic particle probability; or (3) determining a predicted empty probability of the recipient cell by reducing a present empty probability of the recipient cell based on the dynamic particle probability; or (4) determining a predicted unknown probability of the recipient cell by increasing a present unknown probability of the recipient cell based on the dynamic particle probability; or any combination of two or more of (1)-(4). For example, the occupancy information unit 560 or other entity may determine any of the predicted sub-state probabilities according to respective determinations in Equation (5) or using one or more other determinations (e.g., reducing the dynamic particle probability, e.g., by multiplying by a value less than one). The processor 510, possibly in combination with the memory 530, or the processor 410 possibly in combination with the memory 411, may comprise means for determining the predicted static probability, means for determining the predicted dynamic probability, means for determining the predicted empty probability, and/or means for determining the predicted unknown probability. In a further example implementation, the dynamic particle probability is a composite dynamic particle probability, the dynamic particle is a first dynamic particle, the donor cell is a first donor cell, and wherein determining the one or more predicted probabilities comprises: determining a second probability that a second dynamic particle will move from a second donor cell to the recipient cell of the occupancy grid; and determining the composite dynamic particle probability by adding the first probability and the second probability. For example, the occupancy information unit 560 or other entity may determine the composite dynamic particle probability according to Equation (8) and determine the predicted probability of one of the end cells 1111-1115, e.g., based on any of the predicted sub-state probabilities according to respective determinations in Equation (9), or other predicted-sub-state probability determinations. The processor 510, possibly in combination with the memory 530, or the processor 410 possibly in combination with the memory 411, may comprise means for determining the second probability and means for determining the composite dynamic particle probability.

Also or alternatively, implementations of the method 1200 may include one or more of the following features. In an example implementation, determining the one or more predicted probabilities comprises: (1) determining a predicted static probability of the recipient cell by subtracting, from a present static probability of the recipient cell, a first product of the dynamic particle probability and the present static probability of the recipient cell; or (2) determining a predicted dynamic probability of the recipient cell by adding, to a present dynamic probability of the recipient cell, a second product of the dynamic particle probability and a present empty probability of the recipient cell; or (3) determining a predicted empty probability of the recipient cell by subtracting, from the present empty probability of the recipient cell, a third product of the dynamic particle probability and the present empty probability of the recipient cell; or (4) determining a predicted unknown probability of the recipient cell by adding, to a present unknown probability of the recipient cell, a fourth product of the dynamic particle probability and the present static probability of the donor cell; or any combination of two or more of (1)-(4). For example, the occupancy information unit 560 or other entity may determine any of the predicted sub-state probabilities according to respective determinations in Equation (9) or using one or more other determinations (e.g., reducing the dynamic particle probability, e.g., by multiplying by a value less than one). The processor 510, possibly in combination with the memory 530, or the processor 410 possibly in combination with the memory 411, may comprise means for determining the predicted static probability, means for determining the predicted dynamic probability, means for determining the predicted empty probability, and/or means for determining the predicted unknown probability.

### IMPLEMENTATION EXAMPLES

Implementation examples are provided in the following numbered clauses.

Clause 1. An apparatus comprising:

a memory; and

a processor communicatively coupled to the memory, and configured to:
determine a dynamic particle probability based on a first probability that a dynamic particle will move from a donor cell of an occupancy grid to a recipient cell of the occupancy grid; and
determine one or more predicted probabilities of at least one of the donor cell or the recipient cell based on the dynamic particle probability.

Clause 2. The apparatus of clause 1, wherein to determine the one or more predicted probabilities:

the processor is configured to determine a predicted dynamic probability of the donor cell by reducing a present dynamic probability of the donor cell based on the dynamic particle probability; or

the processor is configured to determine a predicted empty probability of the donor cell by increasing a present empty probability of the donor cell based on the dynamic particle probability; or

a combination thereof.

Clause 3. The apparatus of clause 2, wherein the dynamic particle probability is a composite dynamic particle probability, the dynamic particle is a first dynamic particle, the recipient cell is a first recipient cell, and to determine the one or more predicted probabilities the processor is further configured to:

determine a second probability that a second dynamic particle will move from the donor cell to a second recipient cell of the occupancy grid; and

determine the composite dynamic particle probability by adding the first probability and the second probability.

Clause 4. The apparatus of clause 1, wherein to determine the one or more predicted probabilities:

the processor is configured to determine a predicted dynamic probability of the donor cell by subtracting the dynamic particle probability from a present dynamic probability of the donor cell; or

the processor is configured to determine a predicted empty probability of the donor cell by adding the dynamic particle probability to a present empty probability of the donor cell; or

a combination thereof.

Clause 5. The apparatus of clause 1, wherein to determine the one or more predicted probabilities:

(1) the processor is configured to determine a predicted static probability of the recipient cell by reducing a present static probability of the recipient cell based on the dynamic particle probability; or

(2) the processor is configured to determine a predicted dynamic probability of the recipient cell by increasing a present dynamic probability of the recipient cell based on the dynamic particle probability; or

(3) the processor is configured to determine a predicted empty probability of the recipient cell by reducing a present empty probability of the recipient cell based on the dynamic particle probability; or

(4) the processor is configured to determine a predicted unknown probability of the recipient cell by increasing a present unknown probability of the recipient cell based on the dynamic particle probability;

any combination of two or more of (1)-(4).

Clause 6. The apparatus of clause 5, wherein the dynamic particle probability is a composite dynamic particle probability, the dynamic particle is a first dynamic particle, the donor cell is a first donor cell, and to determine the one or more predicted probabilities the processor is further configured to:

determine a second probability that a second dynamic particle will move from a second donor cell to the recipient cell of the occupancy grid; and

determine the composite dynamic particle probability by adding the first probability and the second probability.

Clause 7. The apparatus of clause 1, wherein to determine the one or more predicted probabilities:

(1) the processor is configured to determine a predicted static probability of the recipient cell by subtracting, from a present static probability of the recipient cell, a first product of the dynamic particle probability and the present static probability of the recipient cell; or (2) the processor is configured to determine a predicted dynamic probability of the recipient cell by adding, to a present dynamic probability of the recipient cell, a second product of the dynamic particle probability and a present empty probability of the recipient cell; or

(3) the processor is configured to determine a predicted empty probability of the recipient cell by subtracting, from the present empty probability of the recipient cell, a third product of the dynamic particle probability and the present empty probability of the recipient cell; or

(4) the processor is configured to determine a predicted unknown probability of the recipient cell by adding, to a present unknown probability of the recipient cell, a fourth product of the dynamic particle probability and the present static probability of the donor cell; or

any combination of two or more of (1)-(4).

Clause 8. An occupancy grid probability prediction method comprising:

determining a dynamic particle probability based on a first probability that a dynamic particle will move from a donor cell of an occupancy grid to a recipient cell of the occupancy grid; and

determining one or more predicted probabilities of at least one of the donor cell or the recipient cell based on the dynamic particle probability.

Clause 9. The occupancy grid probability prediction method of clause 8, wherein determining the one or more predicted probabilities comprises:

determining a predicted dynamic probability of the donor cell by reducing a present dynamic probability of the donor cell based on the dynamic particle probability; or

determining a predicted empty probability of the donor cell by increasing a present empty probability of the donor cell based on the dynamic particle probability; or

a combination thereof.

Clause 10. The occupancy grid probability prediction method of clause 9, wherein the dynamic particle probability is a composite dynamic particle probability, the dynamic particle is a first dynamic particle, the recipient cell is a first recipient cell, and wherein determining the one or more predicted probabilities comprises:

determining a second probability that a second dynamic particle will move from the donor cell to a second recipient cell of the occupancy grid; and

determining the composite dynamic particle probability by adding the first probability and the second probability.

Clause 11. The occupancy grid probability prediction method of clause 8, wherein determining the one or more predicted probabilities comprises:

determining a predicted dynamic probability of the donor cell by subtracting the dynamic particle probability from a present dynamic probability of the donor cell; or

determining a predicted empty probability of the donor cell by adding the dynamic particle probability to a present empty probability of the donor cell; or

a combination thereof.

Clause 12. The occupancy grid probability prediction method of clause 8, wherein determining the one or more predicted probabilities comprises:

(1) determining a predicted static probability of the recipient cell by reducing a present static probability of the recipient cell based on the dynamic particle probability; or

(2) determining a predicted dynamic probability of the recipient cell by increasing a present dynamic probability of the recipient cell based on the dynamic particle probability; or

(3) determining a predicted empty probability of the recipient cell by reducing a present empty probability of the recipient cell based on the dynamic particle probability; or

(4) determining a predicted unknown probability of the recipient cell by increasing a present unknown probability of the recipient cell based on the dynamic particle probability; or

any combination of two or more of (1)-(4).

Clause 13. The occupancy grid probability prediction method of clause 12, wherein the dynamic particle probability is a composite dynamic particle probability, the dynamic particle is a first dynamic particle, the donor cell is a first donor cell, and wherein determining the one or more predicted probabilities comprises:

determining a second probability that a second dynamic particle will move from a second donor cell to the recipient cell of the occupancy grid; and

determining the composite dynamic particle probability by adding the first probability and the second probability.

Clause 14. The occupancy grid probability prediction method of clause 8, wherein determining the one or more predicted probabilities comprises:

(1) determining a predicted static probability of the recipient cell by subtracting, from a present static probability of the recipient cell, a first product of the dynamic particle probability and the present static probability of the recipient cell; or

(2) determining a predicted dynamic probability of the recipient cell by adding, to a present dynamic probability of the recipient cell, a second product of the dynamic particle probability and a present empty probability of the recipient cell; or

(3) determining a predicted empty probability of the recipient cell by subtracting, from the present empty probability of the recipient cell, a third product of the dynamic particle probability and the present empty probability of the recipient cell; or

(4) determining a predicted unknown probability of the recipient cell by adding, to a present unknown probability of the recipient cell, a fourth product of the dynamic particle probability and the present static probability of the donor cell; or

any combination of two or more of (1)-(4).

Clause 15. An apparatus comprising:

means for determining a dynamic particle probability based on a first probability that a dynamic particle will move from a donor cell of an occupancy grid to a recipient cell of the occupancy grid; and

means for determining one or more predicted probabilities of at least one of the donor cell or the recipient cell based on the dynamic particle probability.

Clause 16. The apparatus of clause 15, wherein the means for determining the one or more predicted probabilities comprise:

means for determining a predicted dynamic probability of the donor cell by reducing a present dynamic probability of the donor cell based on the dynamic particle probability; or

means for determining a predicted empty probability of the donor cell by increasing a present empty probability of the donor cell based on the dynamic particle probability; or

a combination thereof.

Clause 17. The apparatus of clause 16, wherein the dynamic particle probability is a composite dynamic particle probability, the dynamic particle is a first dynamic particle, the recipient cell is a first recipient cell, and wherein the means for determining the one or more predicted probabilities comprise:

means for determining a second probability that a second dynamic particle will move from the donor cell to a second recipient cell of the occupancy grid; and

means for determining the composite dynamic particle probability by adding the first probability and the second probability.

Clause 18. The apparatus of clause 15, wherein the means for determining the one or more predicted probabilities comprise:

means for determining a predicted dynamic probability of the donor cell by subtracting the dynamic particle probability from a present dynamic probability of the donor cell; or

means for determining a predicted empty probability of the donor cell by adding the dynamic particle probability to a present empty probability of the donor cell; or

a combination thereof.

Clause 19. The apparatus of clause 15, wherein the means for determining the one or more predicted probabilities comprise:

(1) means for determining a predicted static probability of the recipient cell by reducing a present static probability of the recipient cell based on the dynamic particle probability; or

(2) means for determining a predicted dynamic probability of the recipient cell by increasing a present dynamic probability of the recipient cell based on the dynamic particle probability; or

(3) means for determining a predicted empty probability of the recipient cell by reducing a present empty probability of the recipient cell based on the dynamic particle probability; or

(4) means for determining a predicted unknown probability of the recipient cell by increasing a present unknown probability of the recipient cell based on the dynamic particle probability; or

any combination of two or more of (1)-(4).

Clause 20. The apparatus of clause 19, wherein the dynamic particle probability is a composite dynamic particle probability, the dynamic particle is a first dynamic particle, the donor cell is a first donor cell, and wherein the means for determining the one or more predicted probabilities comprise:

means for determining a second probability that a second dynamic particle will move from a second donor cell to the recipient cell of the occupancy grid; and

means for determining the composite dynamic particle probability by adding the first probability and the second probability.

Clause 21. The apparatus of clause 15, wherein the means for determining the one or more predicted probabilities comprise:

(1) means for determining a predicted static probability of the recipient cell by subtracting, from a present static probability of the recipient cell, a first product of the dynamic particle probability and the present static probability of the recipient cell; or

(2) means for determining a predicted dynamic probability of the recipient cell by adding, to a present dynamic probability of the recipient cell, a second product of the dynamic particle probability and a present empty probability of the recipient cell; or

(3) means for determining a predicted empty probability of the recipient cell by subtracting, from the present empty probability of the recipient cell, a third product of the dynamic particle probability and the present empty probability of the recipient cell; or

(4) means for determining a predicted unknown probability of the recipient cell by adding, to a present unknown probability of the recipient cell, a fourth product of the dynamic particle probability and the present static probability of the donor cell; or

any combination of two or more of (1)-(4).

Clause 22. A non-transitory, processor-readable storage medium comprising processor-readable instructions to cause a processor to:

determine a dynamic particle probability based on a first probability that a dynamic particle will move from a donor cell of an occupancy grid to a recipient cell of the occupancy grid; and

determine one or more predicted probabilities of at least one of the donor cell or the recipient cell based on the dynamic particle probability.

Clause 23. The non-transitory, processor-readable storage medium of clause 22, wherein the processor-readable instructions to cause the processor to determine the one or more predicted probabilities comprise:

processor-readable instructions to cause the processor to determine a predicted dynamic probability of the donor cell by reducing a present dynamic probability of the donor cell based on the dynamic particle probability; or

processor-readable instructions to cause the processor to determine a predicted empty probability of the donor cell by increasing a present empty probability of the donor cell based on the dynamic particle probability; or

a combination thereof.

Clause 24. The non-transitory, processor-readable storage medium of clause 23, wherein the dynamic particle probability is a composite dynamic particle probability, the dynamic particle is a first dynamic particle, the recipient cell is a first recipient cell, and wherein the processor-readable instructions to cause the processor to determine the one or more predicted probabilities comprise processor-readable instructions to cause the processor to:

determine a second probability that a second dynamic particle will move from the donor cell to a second recipient cell of the occupancy grid; and

determine the composite dynamic particle probability by adding the first probability and the second probability.

Clause 25. The non-transitory, processor-readable storage medium of clause 22, wherein the processor-readable instructions to cause the processor to determine the one or more predicted probabilities comprise:

processor-readable instructions to cause the processor to determine a predicted dynamic probability of the donor cell by subtracting the dynamic particle probability from a present dynamic probability of the donor cell; or

processor-readable instructions to cause the processor to determine a predicted empty probability of the donor cell by adding the dynamic particle probability to a present empty probability of the donor cell; or

a combination thereof.

Clause 26. The non-transitory, processor-readable storage medium of clause 22, wherein the processor-readable instructions to cause the processor to determine the one or more predicted probabilities comprise:

(1) processor-readable instructions to cause the processor to determine a predicted static probability of the recipient cell by reducing a present static probability of the recipient cell based on the dynamic particle probability; or

(2) processor-readable instructions to cause the processor to determine a predicted dynamic probability of the recipient cell by increasing a present dynamic probability of the recipient cell based on the dynamic particle probability; or

(3) processor-readable instructions to cause the processor to determine a predicted empty probability of the recipient cell by reducing a present empty probability of the recipient cell based on the dynamic particle probability; or

(4) processor-readable instructions to cause the processor to determine a predicted unknown probability of the recipient cell by increasing a present unknown probability of the recipient cell based on the dynamic particle probability; or

any combination of two or more of (1)-(4).

Clause 27. The non-transitory, processor-readable storage medium of clause 26, wherein the dynamic particle probability is a composite dynamic particle probability, the dynamic particle is a first dynamic particle, the donor cell is a first donor cell, and wherein the processor-readable instructions to cause the processor to determine the one or more predicted probabilities comprise processor-readable instructions to cause the processor to:

determine a second probability that a second dynamic particle will move from a second donor cell to the recipient cell of the occupancy grid; and

determine the composite dynamic particle probability by adding the first probability and the second probability.

Clause 28. The non-transitory, processor-readable storage medium of clause 22, wherein the processor-readable instructions to cause the processor to determine the one or more predicted probabilities comprise processor-readable instructions to cause the processor to:

(1) processor-readable instructions to cause the processor to determine a predicted static probability of the recipient cell by subtracting, from a present static probability of the recipient cell, a first product of the dynamic particle probability and the present static probability of the recipient cell; or

(2) processor-readable instructions to cause the processor to determine a predicted dynamic probability of the recipient cell by adding, to a present dynamic probability of the recipient cell, a second product of the dynamic particle probability and a present empty probability of the recipient cell; or

(3) processor-readable instructions to cause the processor to determine a predicted empty probability of the recipient cell by subtracting, from the present empty probability of the recipient cell, a third product of the dynamic particle probability and the present empty probability of the recipient cell; or

(4) processor-readable instructions to cause the processor to determine a predicted unknown probability of the recipient cell by adding, to a present unknown probability of the recipient cell, a fourth product of the dynamic particle probability and the present static probability of the donor cell; or

any combination of two or more of (1)-(4).

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. Thus, reference to a device in the singular (e.g., “a device,” “the device”), including in the claims, includes at least one, i.e., one or more, of such devices (e.g., “a processor” includes at least one processor (e.g., one processor, two processors, etc.), “the processor” includes at least one processor, “a memory” includes at least one memory, “the memory” includes at least one memory, etc.). The phrases “at least one” and “one or more” are used interchangeably and such that “at least one” referred-to object and “one or more” referred-to objects include implementations that have one referred-to object and implementations that have multiple referred-to objects. For example, “at least one processor” and “one or more processors” each includes implementations that have one processor and implementations that have multiple processors.

The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description herein to provide a thorough understanding of example configurations (including implementations). However, configurations may be practiced without these specific details. For example, well-known circuits, processes, algorithms, structures, and techniques have been shown without unnecessary detail in order to avoid obscuring the configurations. The description herein provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or ±0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or ±0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. An apparatus comprising:
a memory; and
a processor communicatively coupled to the memory, and configured to:
determine a dynamic particle probability based on a first probability that a dynamic particle will move from a donor cell of an occupancy grid to a recipient cell of the occupancy grid; and
determine one or more predicted probabilities of at least one of the donor cell or the recipient cell based on the dynamic particle probability.

2. The apparatus of claim 1, wherein to determine the one or more predicted probabilities:
the processor is configured to determine a predicted dynamic probability of the donor cell by reducing a present dynamic probability of the donor cell based on the dynamic particle probability; or
the processor is configured to determine a predicted empty probability of the donor cell by increasing a present empty probability of the donor cell based on the dynamic particle probability; or
a combination thereof.

3. The apparatus of claim 2, wherein the dynamic particle probability is a composite dynamic particle probability, the dynamic particle is a first dynamic particle, the recipient cell is a first recipient cell, and to determine the one or more predicted probabilities the processor is further configured to:
determine a second probability that a second dynamic particle will move from the donor cell to a second recipient cell of the occupancy grid; and
determine the composite dynamic particle probability by adding the first probability and the second probability.

4. The apparatus of claim 1, wherein to determine the one or more predicted probabilities:
the processor is configured to determine a predicted dynamic probability of the donor cell by subtracting the dynamic particle probability from a present dynamic probability of the donor cell; or
the processor is configured to determine a predicted empty probability of the donor cell by adding the dynamic particle probability to a present empty probability of the donor cell; or
a combination thereof.

5. The apparatus of claim 1, wherein to determine the one or more predicted probabilities:
(1) the processor is configured to determine a predicted static probability of the recipient cell by reducing a present static probability of the recipient cell based on the dynamic particle probability; or
(2) the processor is configured to determine a predicted dynamic probability of the recipient cell by increasing a present dynamic probability of the recipient cell based on the dynamic particle probability; or
(3) the processor is configured to determine a predicted empty probability of the recipient cell by reducing a present empty probability of the recipient cell based on the dynamic particle probability; or
(4) the processor is configured to determine a predicted unknown probability of the recipient cell by increasing a present unknown probability of the recipient cell based on the dynamic particle probability;
any combination of two or more of (1)-(4).

6. The apparatus of claim 5, wherein the dynamic particle probability is a composite dynamic particle probability, the dynamic particle is a first dynamic particle, the donor cell is a first donor cell, and to determine the one or more predicted probabilities the processor is further configured to:
determine a second probability that a second dynamic particle will move from a second donor cell to the recipient cell of the occupancy grid; and
determine the composite dynamic particle probability by adding the first probability and the second probability.

7. The apparatus of claim 1, wherein to determine the one or more predicted probabilities:
(1) the processor is configured to determine a predicted static probability of the recipient cell by subtracting, from a present static probability of the recipient cell, a first product of the dynamic particle probability and the present static probability of the recipient cell; or
(2) the processor is configured to determine a predicted dynamic probability of the recipient cell by adding, to a present dynamic probability of the recipient cell, a second product of the dynamic particle probability and a present empty probability of the recipient cell; or
(3) the processor is configured to determine a predicted empty probability of the recipient cell by subtracting, from the present empty probability of the recipient cell, a third product of the dynamic particle probability and the present empty probability of the recipient cell; or
(4) the processor is configured to determine a predicted unknown probability of the recipient cell by adding, to a present unknown probability of the recipient cell, a fourth product of the dynamic particle probability and the present static probability of the donor cell; or
any combination of two or more of (1)-(4).

8. An occupancy grid probability prediction method comprising:
determining a dynamic particle probability based on a first probability that a dynamic particle will move from a donor cell of an occupancy grid to a recipient cell of the occupancy grid; and
determining one or more predicted probabilities of at least one of the donor cell or the recipient cell based on the dynamic particle probability.

9. The occupancy grid probability prediction method of claim 8, wherein determining the one or more predicted probabilities comprises:
determining a predicted dynamic probability of the donor cell by reducing a present dynamic probability of the donor cell based on the dynamic particle probability; or
determining a predicted empty probability of the donor cell by increasing a present empty probability of the donor cell based on the dynamic particle probability; or a combination thereof.

10. The occupancy grid probability prediction method of claim 9, wherein the dynamic particle probability is a composite dynamic particle probability, the dynamic particle is a first dynamic particle, the recipient cell is a first recipient cell, and wherein determining the one or more predicted probabilities comprises:
determining a second probability that a second dynamic particle will move from the donor cell to a second recipient cell of the occupancy grid; and
determining the composite dynamic particle probability by adding the first probability and the second probability.

11. The occupancy grid probability prediction method of claim 8, wherein determining the one or more predicted probabilities comprises:
determining a predicted dynamic probability of the donor cell by subtracting the dynamic particle probability from a present dynamic probability of the donor cell; or
determining a predicted empty probability of the donor cell by adding the dynamic particle probability to a present empty probability of the donor cell; or
a combination thereof.

12. The occupancy grid probability prediction method of claim 8, wherein determining the one or more predicted probabilities comprises:
(1) determining a predicted static probability of the recipient cell by reducing a present static probability of the recipient cell based on the dynamic particle probability; or
(2) determining a predicted dynamic probability of the recipient cell by increasing a present dynamic probability of the recipient cell based on the dynamic particle probability; or
(3) determining a predicted empty probability of the recipient cell by reducing a present empty probability of the recipient cell based on the dynamic particle probability; or
(4) determining a predicted unknown probability of the recipient cell by increasing a present unknown probability of the recipient cell based on the dynamic particle probability; or
any combination of two or more of (1)-(4).

13. The occupancy grid probability prediction method of claim 12, wherein the dynamic particle probability is a composite dynamic particle probability, the dynamic particle is a first dynamic particle, the donor cell is a first donor cell, and wherein determining the one or more predicted probabilities comprises:
determining a second probability that a second dynamic particle will move from a second donor cell to the recipient cell of the occupancy grid; and
determining the composite dynamic particle probability by adding the first probability and the second probability.

14. The occupancy grid probability prediction method of claim 8, wherein determining the one or more predicted probabilities comprises:
(1) determining a predicted static probability of the recipient cell by subtracting, from a present static probability of the recipient cell, a first product of the dynamic particle probability and the present static probability of the recipient cell; or
(2) determining a predicted dynamic probability of the recipient cell by adding, to a present dynamic probability of the recipient cell, a second product of the dynamic particle probability and a present empty probability of the recipient cell; or
(3) determining a predicted empty probability of the recipient cell by subtracting, from the present empty probability of the recipient cell, a third product of the dynamic particle probability and the present empty probability of the recipient cell; or
(4) determining a predicted unknown probability of the recipient cell by adding, to a present unknown probability of the recipient cell, a fourth product of the dynamic particle probability and the present static probability of the donor cell; or
any combination of two or more of (1)-(4).

15. An apparatus comprising:
means for determining a dynamic particle probability based on a first probability that a dynamic particle will move from a donor cell of an occupancy grid to a recipient cell of the occupancy grid; and
means for determining one or more predicted probabilities of at least one of the donor cell or the recipient cell based on the dynamic particle probability.

16. The apparatus of claim 15, wherein the means for determining the one or more predicted probabilities comprise:
means for determining a predicted dynamic probability of the donor cell by reducing a present dynamic probability of the donor cell based on the dynamic particle probability; or
means for determining a predicted empty probability of the donor cell by increasing a present empty probability of the donor cell based on the dynamic particle probability; or
a combination thereof.

17. The apparatus of claim 16, wherein the dynamic particle probability is a composite dynamic particle probability, the dynamic particle is a first dynamic particle, the recipient cell is a first recipient cell, and wherein the means for determining the one or more predicted probabilities comprise:
means for determining a second probability that a second dynamic particle will move from the donor cell to a second recipient cell of the occupancy grid; and
means for determining the composite dynamic particle probability by adding the first probability and the second probability.

18. The apparatus of claim 15, wherein the means for determining the one or more predicted probabilities comprise:
means for determining a predicted dynamic probability of the donor cell by subtracting the dynamic particle probability from a present dynamic probability of the donor cell; or
means for determining a predicted empty probability of the donor cell by adding the dynamic particle probability to a present empty probability of the donor cell; or
a combination thereof.

19. The apparatus of claim 15, wherein the means for determining the one or more predicted probabilities comprise:
(1) means for determining a predicted static probability of the recipient cell by reducing a present static probability of the recipient cell based on the dynamic particle probability; or
(2) means for determining a predicted dynamic probability of the recipient cell by increasing a present dynamic probability of the recipient cell based on the dynamic particle probability; or
(3) means for determining a predicted empty probability of the recipient cell by reducing a present empty probability of the recipient cell based on the dynamic particle probability; or
(4) means for determining a predicted unknown probability of the recipient cell by increasing a present unknown probability of the recipient cell based on the dynamic particle probability; or
any combination of two or more of (1)-(4).

20. The apparatus of claim 19, wherein the dynamic particle probability is a composite dynamic particle probability, the dynamic particle is a first dynamic particle, the donor cell is a first donor cell, and wherein the means for determining the one or more predicted probabilities comprise:
means for determining a second probability that a second dynamic particle will move from a second donor cell to the recipient cell of the occupancy grid; and
means for determining the composite dynamic particle probability by adding the first probability and the second probability.

21. The apparatus of claim 15, wherein the means for determining the one or more predicted probabilities comprise:
(1) means for determining a predicted static probability of the recipient cell by subtracting, from a present static probability of the recipient cell, a first product of the dynamic particle probability and the present static probability of the recipient cell; or
(2) means for determining a predicted dynamic probability of the recipient cell by adding, to a present dynamic probability of the recipient cell, a second product of the dynamic particle probability and a present empty probability of the recipient cell; or
(3) means for determining a predicted empty probability of the recipient cell by subtracting, from the present empty probability of the recipient cell, a third product of the dynamic particle probability and the present empty probability of the recipient cell; or
(4) means for determining a predicted unknown probability of the recipient cell by adding, to a present unknown probability of the recipient cell, a fourth product of the dynamic particle probability and the present static probability of the donor cell; or
any combination of two or more of (1)-(4).

22. A non-transitory, processor-readable storage medium comprising processor-readable instructions to cause a processor to:
determine a dynamic particle probability based on a first probability that a dynamic particle will move from a donor cell of an occupancy grid to a recipient cell of the occupancy grid; and
determine one or more predicted probabilities of at least one of the donor cell or the recipient cell based on the dynamic particle probability.

23. The non-transitory, processor-readable storage medium of claim 22, wherein the processor-readable instructions to cause the processor to determine the one or more predicted probabilities comprise:
processor-readable instructions to cause the processor to determine a predicted dynamic probability of the donor cell by reducing a present dynamic probability of the donor cell based on the dynamic particle probability; or
processor-readable instructions to cause the processor to determine a predicted empty probability of the donor cell by increasing a present empty probability of the donor cell based on the dynamic particle probability; or
a combination thereof.

24. The non-transitory, processor-readable storage medium of claim 23, wherein the dynamic particle probability is a composite dynamic particle probability, the dynamic particle is a first dynamic particle, the recipient cell is a first recipient cell, and wherein the processor-readable instructions to cause the processor to determine the one or more predicted probabilities comprise processor-readable instructions to cause the processor to:
determine a second probability that a second dynamic particle will move from the donor cell to a second recipient cell of the occupancy grid; and
determine the composite dynamic particle probability by adding the first probability and the second probability.

25. The non-transitory, processor-readable storage medium of claim 22, wherein the processor-readable instructions to cause the processor to determine the one or more predicted probabilities comprise:
processor-readable instructions to cause the processor to determine a predicted dynamic probability of the donor cell by subtracting the dynamic particle probability from a present dynamic probability of the donor cell; or
processor-readable instructions to cause the processor to determine a predicted empty probability of the donor cell by adding the dynamic particle probability to a present empty probability of the donor cell; or
a combination thereof.

26. The non-transitory, processor-readable storage medium of claim 22, wherein the processor-readable instructions to cause the processor to determine the one or more predicted probabilities comprise:
(1) processor-readable instructions to cause the processor to determine a predicted static probability of the recipient cell by reducing a present static probability of the recipient cell based on the dynamic particle probability; or
(2) processor-readable instructions to cause the processor to determine a predicted dynamic probability of the recipient cell by increasing a present dynamic probability of the recipient cell based on the dynamic particle probability; or
(3) processor-readable instructions to cause the processor to determine a predicted empty probability of the recipient cell by reducing a present empty probability of the recipient cell based on the dynamic particle probability; or
(4) processor-readable instructions to cause the processor to determine a predicted unknown probability of the recipient cell by increasing a present unknown probability of the recipient cell based on the dynamic particle probability; or
any combination of two or more of (1)-(4).

27. The non-transitory, processor-readable storage medium of claim 26, wherein the dynamic particle probability is a composite dynamic particle probability, the dynamic particle is a first dynamic particle, the donor cell is a first donor cell, and wherein the processor-readable instructions to cause the processor to determine the one or more predicted probabilities comprise processor-readable instructions to cause the processor to:
determine a second probability that a second dynamic particle will move from a second donor cell to the recipient cell of the occupancy grid; and
determine the composite dynamic particle probability by adding the first probability and the second probability.

28. The non-transitory, processor-readable storage medium of claim 22, wherein the processor-readable instructions to cause the processor to determine the one or more predicted probabilities comprise processor-readable instructions to cause the processor to:
(1) processor-readable instructions to cause the processor to determine a predicted static probability of the recipient cell by subtracting, from a present static probability of the recipient cell, a first product of the dynamic particle probability and the present static probability of the recipient cell; or
(2) processor-readable instructions to cause the processor to determine a predicted dynamic probability of the recipient cell by adding, to a present dynamic probability of the recipient cell, a second product of the dynamic particle probability and a present empty probability of the recipient cell; or
(3) processor-readable instructions to cause the processor to determine a predicted empty probability of the recipient cell by subtracting, from the present empty probability of the recipient cell, a third product of the dynamic particle probability and the present empty probability of the recipient cell; or
(4) processor-readable instructions to cause the processor to determine a predicted unknown probability of the recipient cell by adding, to a present unknown probability of the recipient cell, a fourth product of the dynamic particle probability and the present static probability of the donor cell; or
any combination of two or more of (1)-(4).
